(19) United States
(12) Patent Application Publication
(10) Pub. No.: US 2005/0208221 A1
(43) Pub. Date: Sep. 22, 2005

(54) Method for manufacturing sheet with protruding texture as pad or curtain sheet

(76) Inventor: Cheng-Che Hsieh, Tai Nai City (TW)

Correspondence Address: CHENG-CHE HSIEH, 235 CHUNG-HO BOX 8-24, TAIPEI HSIEN, 235, TW

(21) Appl. No.: 10/801,921

(22) Filed: Mar. 17, 2004

(51) Int. Cl. B05D 3/12

(52) U.S. Cl. 427/355

(57) ABSTRACT

A method for manufacturing a sheet with protruding texture is disclosed. The sheet can be made as a pad or curtain sheet. The method comprises the steps of: outputting a bottom film outputted from a bottom film supplier; passing the bottom film around a transfer roller, supplying heating rubber material as a texture material from a texture material supplier and then dropping upon the bottom film on the transfer roller; removing the residual heating rubber material on the transfer roller by a material remover; transferring the bottom plate to a removing roller behind the transfer roller for separating the bottom plate, wherein at this stage, the texture has condensed into solid state; and sending the bottom plate to at least one pair of printing roller; each pair of printing rollers being placed at two sides of the bottom plate so as to print dyes upon the texture.

### FIELD OF THE INVENTION

The present invention relates to a method for forming protruding texture on a sheet, and particular to a method for manufacturing a sheet with protruding texture as a pad or curtain sheet.

### BACKGSEMI-ROUND OF THE INVENTION

The thin pads or curtain sheets are generally used in daily life widely. In generally, they are made of plastics. However, in the prior art, these pads or curtain sheets are smooth so as not to firmly support objects placed thereon. Furthermore, they have dull appearances. Thereby, in some improved structures, particles or protruded textures are formed on the pads or sheets.

Referring to FIG. 1, a prior art manufacturing process for making textured pads or sheets are illustrated. A material adhering roller 2 with concave textures 21 is provided. The roller 2 rolls through a material tank 3 so that rubber material S is adhered on the surface of the roller 2, A material remover 4 is arranged aside the roller 2 for removing residual material S1. Thus, the textured material S2 is filled into the concave textures 21, see FIG. 1-A. Then, the supplying roller 51 supplies a continuous rubber plate P. The plate P passes through a transfer roller 52 adjacent to the roller 2 to adhere the texture material S2 so that the material S2 is adhered to the plate 2, as shown in FIG. 1-B. The plate P is wound by a winding roller 53 as a cylinder so as to form a substrate PA with protruding texture S2. Then the cylinder is moved for punching and cutting to have desired size for forming pads and curtaining sheets so as to be printed with dyes or adhering golden powders.

In above mentioned conventionally manufacturing process, the melt rubber material S is adhered to the concave texture 21 of the roller 2. The melt rubber material S must condense rapidly into solid state so as to be transferred to the surface of the plate P. However, other than the inconvenience of the operation, the substrate PA has a larger volume and is heavy so that the cost is high in transfer and storage. Thereby, the time period for condensing the melt rubber material S is unstable so that the winding step cannot be performed successfully. A part of material S2 is not solidified. This will deform the substrate PA in the winding process. Thereby, it causes that the dye cannot effectively adhere on the substrate.

### SUMMARY OF THE INVENTION

Accordingly, the primary object of the present invention is to provide a method for manufacturing a sheet with protruding texture so that the sheet can be made as a pad or curtain sheet. The method comprising the steps of: outputting a bottom film outputted from a bottom film supplier from a flat opening of the bottom film supplier; passing the bottom film around a transfer roller, supplying heating rubber material as a texture material from a texture material supplier and then dropping upon the bottom film on the transfer roller; removing the residual heating rubber material on the transfer roller removed by a material remover; transferring the bottom plate to a removing roller behind the transfer roller for separating the bottom plate, wherein at this stage, the texture has condensed into solid state; and sending the bottom plate to at least one pair of printing roller; each pair of printing rollers being placed at two sides of the bottom plate so as to print dyes upon texture.

The various objects and advantages of the present invention will be more readily understood from the following detailed description when read in conjunction with the appended drawing.

### BRIEF DESCRIPTION OF THE DRAWINGS

FIG. 1 shows a prior art manufacturing process.

FIG. 1-A is an enlarge view showing the step of removing residual material in the prior art.

FIG. 1-B is an enlarged view showing a plastic plate with protruding texture.

FIG. 2 shows the manufacturing process of the present invention.

FIG. 2-A is an enlarged view showing the step of removing residual material in the present invention.

FIG. 2-B is an enlarged view showing that the protruding texture is formed on a bottom plate according to the present invention.

FIG. 2-C is an enlarged schematic view showing the operation of the printing process according to the present invention.

FIG. 2-D is an enlarged schematic view showing bottom plate after the printing process according to the present invention.

FIG. 3-A is a partial enlarged view showing a texture being formed on the bottom plate according to the present invention.

FIG. 3-B is a partial enlarged view showing that dyes is printed on the bottom plate according to the present invention.

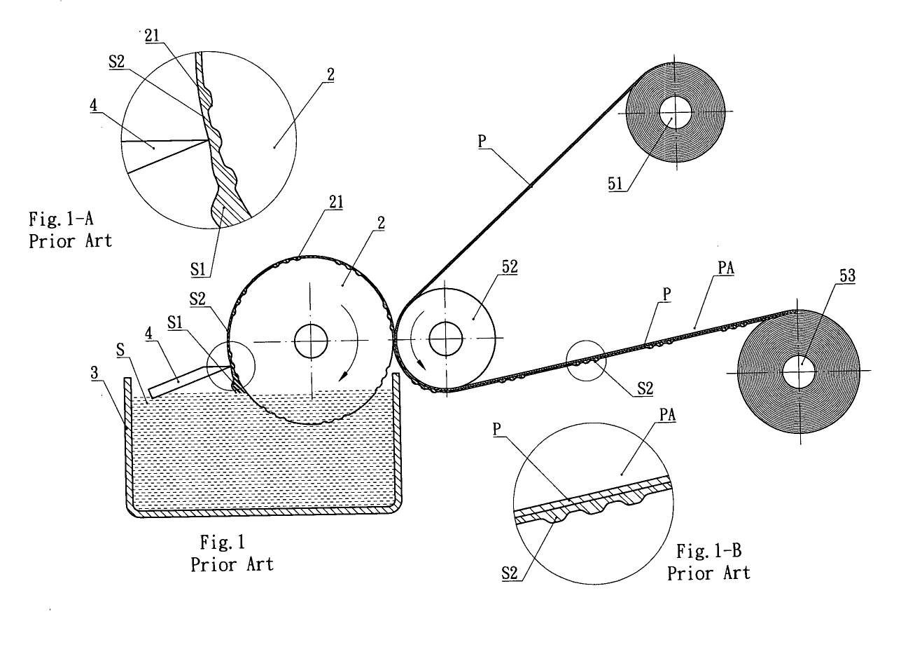

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

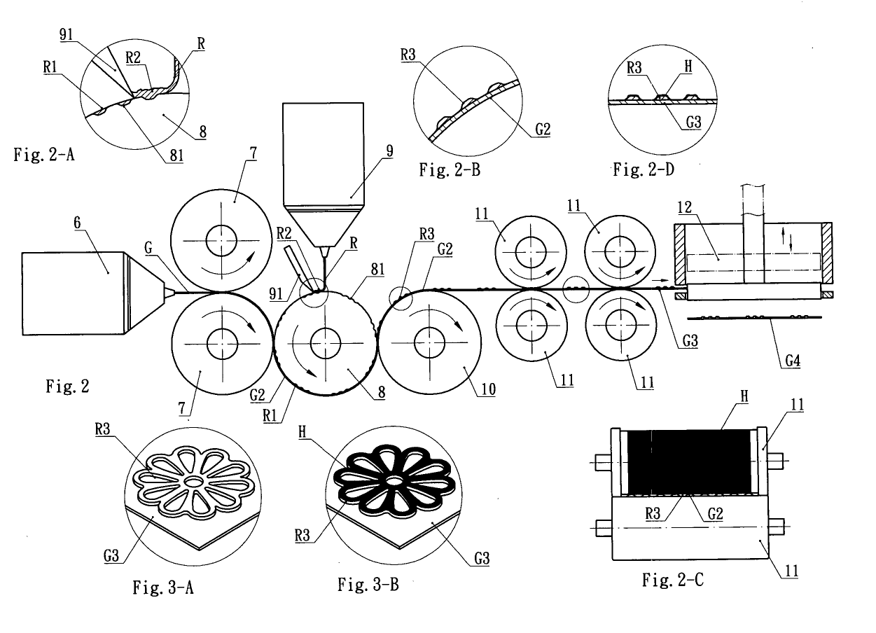

With reference to FIGS. 2 and 3, the method of the present invention includes the following steps.

A bottom film G is outputted from a flat opening of a bottom film supplier 6. The bottom film G passes through a pair of compressing roller 7 at two sides of the bottom film G.

Then the bottom film G passes around a transfer roller 8, wherein a surface of the transfer roller 8 is engraved with texture 81 so that the bottom film G is shaped by the texture 81, see FIG. 2-A.

Heating rubber material R as a texture material is supplied from a texture material supplier 9 and then drops upon the bottom film G on the transfer roller 8. With reference to FIG. 2-A, a part of heating rubber material R1 will fill into lower sections of the texture 81 and is above the bottom film; and a part of heating rubber material R2 will be out of the lower section 2 of the texture 81 as residue. The residual heating rubber material R2 on the transfer roller 8 is removed by a material remover 91 placed aside a dropping location of the heating rubber material R. Thereby, as the heating rubber material R1 cools as a rubber texture R3, the rubber texture R3 will be adhered on the bottom film G as a bottom plate G2 with the rubber material.

The bottom plate G2 is further transferred to a removing roller 10 behind the transfer roller 8 for separating the bottom plate G, wherein at this stage, the texture R3 has condensed into solid state, as shown in FIGS. 2-B and FIG. 3-A.

Referring to FIG. 2-C, then the bottom plate G2 is further transferred to at least one pair of printing roller 11s. Each pair of printing rollers 11 are placed at two sides of the bottom plate G2 so as to print dyes H (or golden powder) upon texture R3 so as to form protruded texture upon the texture R3. Thereby, the bottom plate G2 becomes a printed substrate G3, referring to FIGS. 2-D and 3-B.

The printed substrate G3 is further transferred to a punching and cutting device 12 for punching and cutting the printed substrate G3 as a desired size so that the printed substrate G3 can be made as a decorating pad or a curtain sheet G4 with protruding texture thereon.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for manufacturing a sheet with protruding texture which is capable of being made as a pad or curtain sheet, the method comprising the steps of:
outputting a bottom film outputted from a flat opening of a bottom film supplier;
passing the bottom film through a pair of compressing roller at two sides of the bottom film;
passing the bottom film to be around a transfer roller, wherein a surface of the transfer roller is formed with texture so that the bottom film is shaped with the texture;
supplying heating rubber material as a texture material from a texture material supplier and then dropping upon the bottom film on the transfer roller; wherein a part of heating rubber material fills into lower sections of the texture and on the bottom film; and a part of heating rubber material will be out of the lower section of the texture as residue;
removing the residual heating rubber material on the transfer roller by a material remover; wherein the material remover is placed aside a dropping location of the heating rubber material; as the heating rubber material cools as a rubber texture, the rubber texture will be adhered on the bottom film as a bottom plate having the rubber material;
transferring the bottom plate to a removing roller behind the transfer roller for separating the bottom plate, wherein at this stage, the rubber texture has condensed into solid state; and
sending the bottom plate to at least one pair of printing roller; each pair of printing rollers being placed at two sides of the bottom plate so as to print dyes upon rubber texture to form protruded texture upon the rubber texture; and, the bottom plate being formed as a printed substrate.

2. The method as claimed in claim 1, wherein the printed substrate is further transferred to a punching and cutting device for punching and cutting the printed substrate as a desired size so that the printed substrate is made as a decorating pad or a curtain sheet with protruding texture.
